(19) United States
(12) Patent Application Publication
(10) Pub. No.: US 2013/0221205 A1
(43) Pub. Date: Aug. 29, 2013

(54) LIGHT AMOUNT DETECTOR AND IMAGE FORMING APPARATUS

(71) Applicants: Naoya YAMASAKI, Kanagawa (JP); Kenta OGATA, Kanagawa (JP); Gen NAKAJIMA, Kanagawa (JP)

(72) Inventors: Naoya YAMASAKI, Kanagawa (JP); Kenta OGATA, Kanagawa (JP); Gen NAKAJIMA, Kanagawa (JP)

(73) Assignee: FUJI XEROX CO., LTD., Tokyo (JP)

(21) Appl. No.: 13/598,013

(22) Filed: Aug. 29, 2012

(30) Foreign Application Priority Data
Feb. 29, 2012 (JP) 2012-044360

(51) Int. Cl. G01J 1/02

(52) U.S. Cl. 250/216

(57) ABSTRACT

A light amount detector includes the following elements. An irradiation unit irradiates an image carrier with detection light. A light receiver receives reflected light obtained as a result of being reflected by the image carrier. A housing stores therein the irradiation unit and the light receiver and includes an opposing surface which opposes the image carrier. A window section includes a detection surface through which the detection light is emitted and the reflected light is received. The window section is supported by the housing and is disposed such that the detection surface is positioned farther inward than the opposing surface of the housing. The window section transmits the detection light and the reflected light.

### CROSS-REFERENCE TO RELATED APPLICATIONS

This application is based on and claims priority under 35 USC 119 from Japanese Patent Application No. 2012-044360 filed Feb. 29, 2012.

### BACKGROUND

(i) Technical Field

The present invention relates to a light amount detector and an image forming apparatus.

(ii) Related Art

In order to correct the density of images formed by an image forming apparatus, a technique for forming density detection images on an image carrier and for detecting the density levels of the density detection images is known.

### SUMMARY

According to an aspect of the invention, there is provided a light amount detector including: an irradiation unit that irradiates an image carrier with detection light; a light receiver that receives reflected light obtained as a result of being reflected by the image carrier; a housing that stores therein the irradiation unit and the light receiver and that includes an opposing surface which opposes the image carrier; and a window section that includes a detection surface through which the detection light is emitted and the reflected light is received, that is supported by the housing, that is disposed such that the detection surface is positioned farther inward than the opposing surface of the housing, and that transmits the detection light and the reflected light.

### BRIEF DESCRIPTION OF THE DRAWINGS

Exemplary embodiments of the present invention will be described in detail based on the following figures, wherein:

FIG. 1 is a schematic view illustrating an example of the configuration of an image forming apparatus according to an exemplary embodiment of the invention;

FIG. 2 is a block diagram illustrating the electrical configuration of the image forming apparatus shown in FIG. 1;

FIG. 3 schematically illustrates an example of density detection images formed on an image carrier;

FIGS. 4A through 4C are a perspective view, a sectional view, and a plan view, respectively, illustrating an example of the configuration of a light amount detector according to a first exemplary embodiment;

FIG. 5 is a perspective view illustrating a light amount detector of a modified example of the first exemplary embodiment;

FIG. 6 is a perspective view illustrating an example of the configuration a light amount detector according to a second exemplary embodiment;

FIG. 7 is a perspective view illustrating a light amount detector of a modified example of the second exemplary embodiment;

FIG. 8 is a perspective view illustrating an example of the configuration of a light amount detector according to a third exemplary embodiment; and

FIG. 9 is a sectional view along an optical axis illustrating an example of the configuration of a light amount detector according to a fourth exemplary embodiment.

### DETAILED DESCRIPTION

Exemplary embodiments of the present invention will be described below in detail with reference to the accompanying drawings.

### Image Forming Apparatus

An example of the configuration of an image forming apparatus will be discussed below.

The image forming apparatus is an electrophotographic image forming apparatus that forms images on paper by using an electrophotographic developer including toner. In an exemplary embodiment, a so-called tandem, intermediate-transfer image forming apparatus will be described. The image forming apparatus may be of any type as long as it forms density detection images on an image carrier, detects the density levels of the density detection images, and corrects image density levels. The configuration of the image forming apparatus is not restricted to that described in an exemplary embodiment.

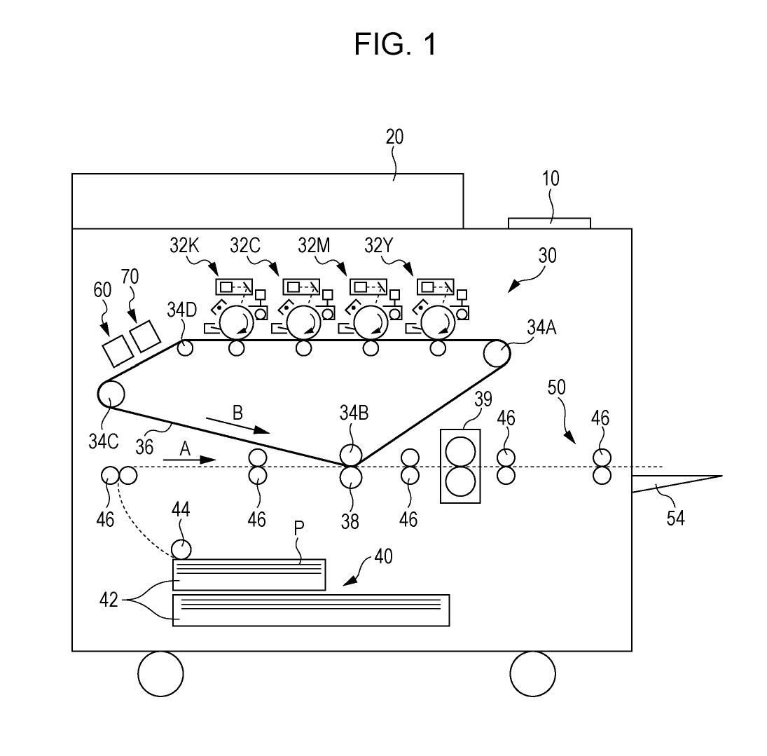

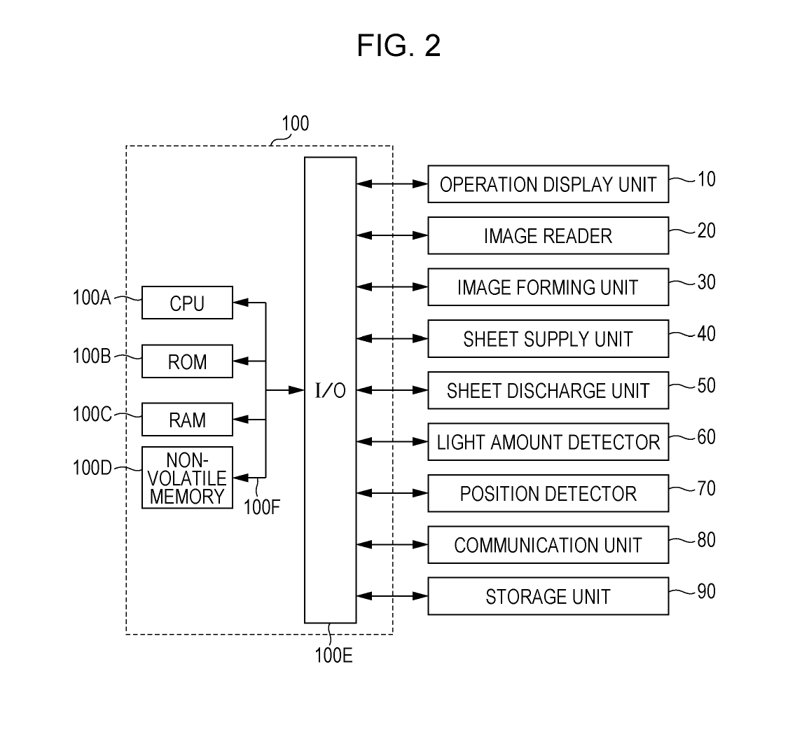

FIG. 1 is a schematic view illustrating an example of the configuration of the image forming apparatus according to an exemplary embodiment. FIG. 2 is a block diagram illustrating the electrical configuration of the image forming apparatus shown in FIG. 1. As shown in FIGS. 1 and 2, the image forming apparatus of an exemplary embodiment includes an operation display unit 10, an image reader 20, an image forming unit 30, a sheet supply unit 40, a sheet discharge unit 50, a light amount detector 60, a position detector 70, a communication unit 80, a storage unit 90, and a controller 100. The image forming unit 30, the sheet supply unit 40, and the sheet discharge unit 50 are disposed in the order of the sheet supply unit 40, the image forming unit 30, and the sheet discharge unit 50, along a sheet transport path indicated by the broken line in FIG. 1.

In an exemplary embodiment, the image carrier is an intermediate transfer belt 36, which will be discussed later. The light amount detector 60 and the position detector 70 are disposed on the periphery of the intermediate transfer belt 36, which forms the image forming unit 30, such that they oppose the intermediate transfer belt 36. The light amount detector 60 is disposed above the intermediate transfer belt 36 so as not to make a detection surface 69, which will be discussed later, dirty due to the dropping of an image forming material (hereinafter referred to as “toner”) from the intermediate transfer belt 36, and measures the amount of light reflected by, for example, density detection images formed on the intermediate transfer belt 36 (downward detection). The light amount detector 60 is disposed on the downstream side of an image forming unit 32 with respect to the direction in which the intermediate transfer belt 36 is moved, and measures amounts of light reflected by density detection images which are formed on the intermediate transfer belt 36 by using the image forming unit 30.

The controller 100 is constituted as a computer that controls the entire image forming apparatus and executes various operations. The controller 100 includes a central processing unit (CPU) 100A, a read only memory (ROM) 100B in which various programs are stored, a random access memory (RAM) 100C used as a work area when programs are executed, a non-volatile memory 100D in which various items of information are stored, and an input/output interface (I/O) 100E. The CPU 100A, the ROM 100B, the RAM 100C, the non-volatile memory 100D, and the I/O 100E are connected to one another via a bus 100F.

The operation display unit 10, the image reader 20, the image forming unit 30, the sheet supply unit 40, the sheet discharge unit 50, the light amount detector 60, the position detector 70, the communication unit 80, and the storage unit 90 are connected to the I/O 100E of the controller 100. The controller 100 controls the operation display unit 10, the image reader 20, the image forming unit 30, the sheet supply unit 40, the sheet discharge unit 50, the light amount detector 60, the position detector 70, the communication unit 80, and the storage unit 90.

The controller 100 obtains detection results output from the light amount detector 60 and the position detector 70 as detection signals. The image forming apparatus includes plural transport rollers 46 which are disposed along the sheet transport path indicated by the broken line shown in FIG. 1. The plural transport rollers 46 are driven by a drive mechanism (not shown), and thereby transports a sheet in accordance with an image forming operation.

The operation display unit 10 includes various buttons, such as a start button and a numeric keypad, and a touch panel used for displaying various screens, such as a warning message screen and a setting screen. With this configuration, the operation display unit 10 receives operations performed by a user and displays various items of information for a user. The image reader 20 includes a charge coupled device (CCD) image sensor, an image reading device that optically reads images formed on paper, a scanning mechanism for scanning paper, etc. With this configuration, the image reader 20 reads images formed on a document which is placed on the image reader 20 and then generates image information.

The image forming unit 30 forms images on paper by using an electrophotographic system. The image forming unit 30 includes an image forming unit 32K that forms black (K) toner images, an image forming unit 32C that forms cyan (C) toner images, an image forming unit 32M that forms magenta (M) toner images, and an image forming unit 32Y that forms yellow (Y) toner images. The image forming unit 30 includes the intermediate transfer belt 36, a second transfer device 38, and a fixing device 39. The intermediate transfer belt 36 is wound on plural rollers 34 such that it is moved in the direction indicated by the arrow B in FIG. 1. The second transfer device 38 simultaneously transfers toner images on the intermediate transfer belt 36 onto paper. The fixing device 39 fixes toner images transferred onto paper.

The image forming units 32K, 32C, 32M, and 32Y are disposed in the order shown in FIG. 1 so that a Y toner image, an M toner image, a C toner image, and a K toner image are formed on the intermediate transfer belt 36 in this order when the intermediate transfer belt 36 is moved in the direction indicated by the arrow B in FIG. 1. Hereinafter, the image forming units 32K, 32C, 32M, and 32Y will be simply referred to as an “image forming unit 32” or “image forming units 32” unless it is necessary to distinguish between the individual colors. The image forming units 32 each include a photoconductor drum, a charging device, an exposure device, a developing device, a transfer device, a cleaning device, etc. The photoconductor drums are formed such that they are rotated in the direction indicated by the arrows.

The rollers 34 include a driver roller 34A, a back support roller 34B, a tension application roller 34C, and a driven roller 34D. The intermediate transfer belt 36 is wound on the driver roller 34A, the back support roller 34B, the tension application roller 34C, and the driven roller 34D. Hereinafter, these rollers 34 will be simply referred to as “plural rollers 34” unless it is necessary to distinguish between them. The plural rollers 34 are driven by a drive mechanism (not shown). The drive roller 34A is driven to rotate by the drive mechanism, thereby causing the intermediate transfer belt 36 to move at a predetermined speed in the direction indicated by the arrow B shown in FIG. 1. The tension application roller 34C is moved outward by the drive mechanism, thereby applying a predetermined tension to the intermediate transfer belt 36.

The image forming unit 30 forms images by the following procedure.

The image forming unit 32K transfers a K toner image onto the intermediate transfer belt 36 in the following manner. The charging device charges the photoconductor drum. The exposure device then exposes the charged photoconductor drum to light corresponding to a K image, thereby forming an electrostatic latent image corresponding to the K image on the photoconductor drum. The developing device then develops the electrostatic latent image formed on the photoconductor drum by using a K toner, thereby forming a K toner image. The transfer device transfers the K toner image formed on the photoconductor drum onto the intermediate transfer belt 36.

Similarly, the image forming unit 32C transfers a C toner image onto the intermediate transfer belt 36. The image forming unit 32M transfers an M toner image onto the intermediate transfer belt 36. The image forming unit 32Y transfers a Y toner image onto the intermediate transfer belt 36. The K, C, M, and Y toner images are superposed on one another, thereby forming “superposed toner images”. The second transfer device 38 simultaneously transfers the superposed toner images on the intermediate transfer belt 36 onto paper. The fixing device 39 heats and pressurizes the superposed images transferred on paper, thereby fixing the superposed images on paper.

The sheet supply unit 40 includes a sheet housing section 42, a supply mechanism for supplying sheets from the sheet housing section 42 to the image forming unit 30, etc. The supply mechanism includes a feeder roller 44 that feeds sheets from the sheet housing section 42 and transports rollers 46. Plural sheet housing sections 42 are provided in accordance with the types and the sizes of sheets. The sheet supply unit 40 feeds sheets from one of the sheet housing sections 42 and supplies the sheets to the image forming unit 30. The sheet discharge unit 50 includes a discharge section 54 to which sheets are discharged, a discharge mechanism for discharging sheets onto the discharge section 54, etc.

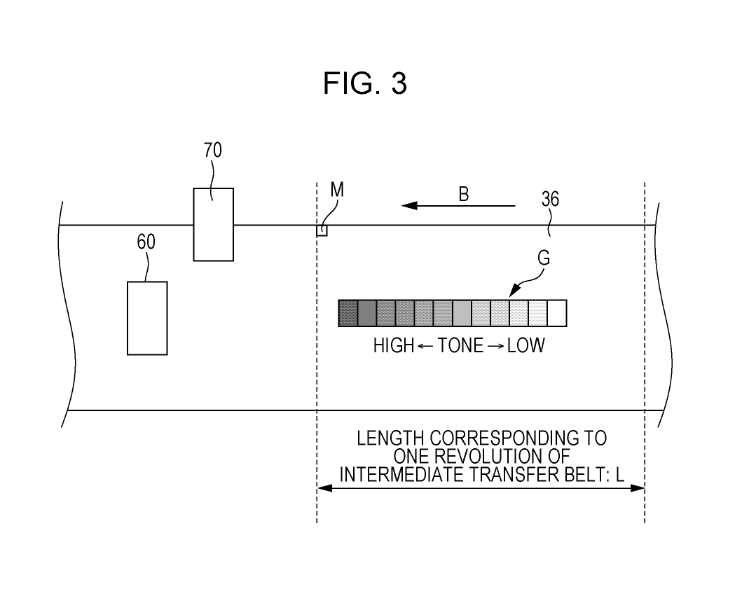

The light amount detector 60 is an optical sensor that irradiates a subject to be detected with detection light and that also detects an amount of light reflected by the subject. A detection signal output from the light amount detector 60 represents an amount of light reflected by the subject. The subject is the intermediate transfer belt 36 on which no density detection image is formed, or a density detection image group G formed on the intermediate transfer belt 36 (see FIG. 3). Details of the configuration of the light amount detector 60 will be given later. Density correction and density detection images will also be discussed later.

The position detector 70 is a position sensor that detects a reference mark M (see FIG. 3) attached on the intermediate transfer belt 36 so as to detect a predetermined reference position. When forming an image, the position detector 70 outputs a position detection signal, which serves as a reference to starting an image forming operation. The position detector 70 irradiates the intermediate transfer belt 36 with light and also receives light reflected by the surface of the mark M, thereby detecting the position of the intermediate transfer belt 36.

The communication unit 80 is an interface through which the image forming apparatus communicates with an external apparatus via a wired or wireless communication line. The communication unit 80 receives print parameters including print attributes, such as the number of pages and the number of print copies, together with print instructions and image information concerning electronic documents. The storage unit 90 includes a storage device, such as a hard disk, and stores therein various data, such as log data, and a control program.

### Density Detection Images

Density detection images will be discussed below.

FIG. 3 schematically illustrates an example of density detection images formed on an image carrier. As shown in FIG. 3, the density detection image group G includes plural density detection images P (hereinafter referred to as “patch images P”). The plural patch images Pare toner images formed of one specific color, e.g., K. The plural patch images P are formed linearly on the intermediate transfer belt 36 in the direction in which the intermediate transfer belt 36 is moved (in the direction indicated by the arrow B in FIG. 3). That is, an image group including an array of the plural patch images P is the density detection image group G. The length L corresponding to one revolution of the intermediate transfer belt 36 is specified by the reference mark M on the intermediate transfer belt 36.

One patch image P is an image formed at a predetermined ratio of the area of the image to a predetermined area. In the example shown in FIG. 3, the plural patch images P have different area ratios. The plural patch images P are aligned such that the area ratios are increased or decreased in the direction in which plural patch images P are aligned. The area ratio of the patch image P is represented by a toner coverage ratio per unit area, e.g., 60%. In this example, the density detection image group G includes twelve patch images P. The area ratios of the twelve patch images P are decreased monotonically from 100% to 0% from the left side to the right side of FIG. 3.

The above-described density detection image group G and reference mark M are only examples, and different images and marks may be used. For example, plural patch images P may include toner images of plural colors (e.g., Y, M, C, and K). The reference mark M may be a mark group constituted of plural colors of marks.

When the intermediate transfer belt 36 is moved in the direction indicated by the arrow B shown in FIG. 3, the position detector 70 detects the reference mark M on the intermediate transfer belt 36, thereby detecting a predetermined reference position. The light amount detector 60 detects the amount of light reflected by the density detection image group G formed on the intermediate transfer belt 36. In this case, the amounts of light components reflected by the patch images P are sequentially detected.

The amount of reflected light detected by the light amount detector 60 varies due to various factors, such as differences in individual optical sensors, the state in which an optical sensor is installed, the presence of an unclean area in the optical path of the optical sensor, and temperature characteristics of the optical sensor. Generally, a change in the amount of reflected light due to the above-described factors is corrected by using the amount of light V_{clean} reflected by the image carrier as a reference value. Correction by using the amount of light V_{clean} is effective particularly in a regular-reflection optical sensor.

However, if the detection surface of the light amount detector 60 gets dirty, the sensitivity of the light amount detector 60 is decreased, which changes the amount of reflected light detected by the light amount detector 60, thereby making it difficult to obtain the correct image density. In an exemplary embodiment, it is less likely that the detection surface of the light amount detector 60 gets dirty, which reduces a variation in the amount of light, thereby detecting the image density with high precision. Density correction processing is then performed by using the obtained image density.

### Configuration of Light Amount Detector

### First Exemplary Embodiment

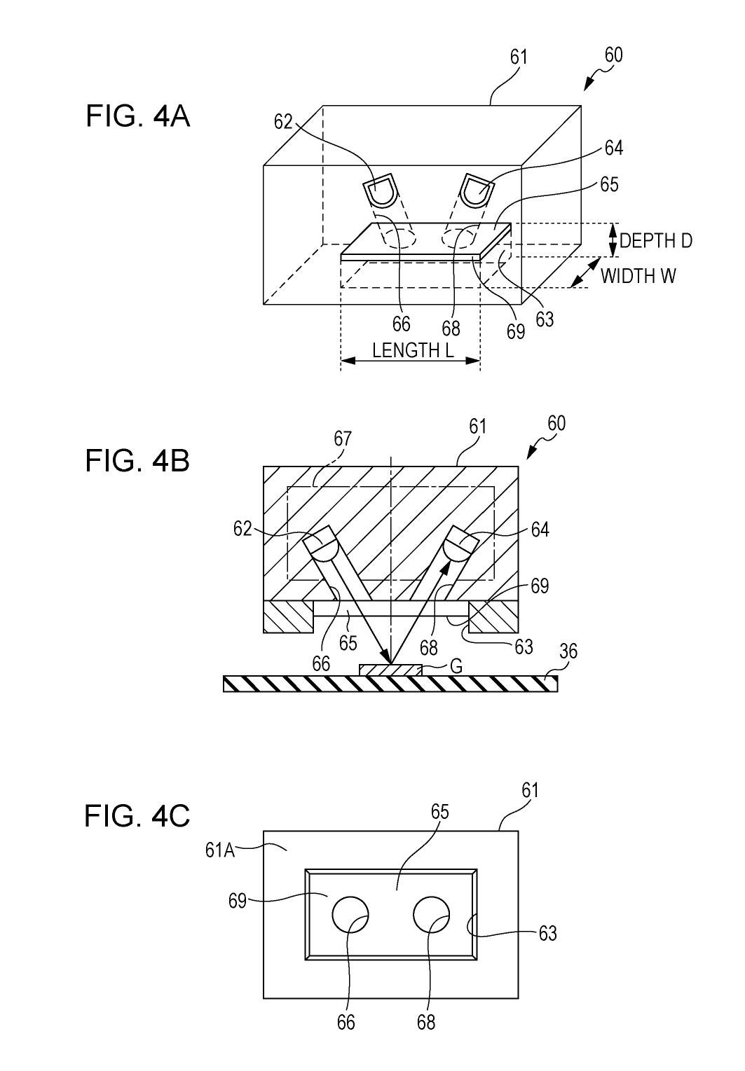

The configuration of a light amount detector 60 according to a first exemplary embodiment will be described below with reference to FIGS. 4A through 4C.

FIG. 4A is a perspective view illustrating the light amount detector 60. FIG. 4B is a sectional view along the optical axis of the light amount detector 60. FIG. 4C is a plan view of the light amount detector 60 as viewed from an image carrier. In the first exemplary embodiment, the light amount detector 60 is a regular-reflection optical sensor. However, the light amount detector 60 is not restricted to this type of sensor.

As illustrated in FIGS. 4A through 4C, the light amount detector 60 includes a light emitting element 62 that emits detection light to be applied to a subject, a light receiving element 64 that receives light reflected by the subject, and a window section 65 that transmits detection light and reflected light. A description will be given below, assuming that the subject is a density detection image group G. The light emitting element 62, the light receiving element 64, and the window section 65 are supported by a support member (not shown) and are housed in a housing 61. The light emitting element 62 and the light receiving element 64 are disposed such that regular reflection light obtained as a result of being regularly reflected by the density detection image group G irradiated with detection light is received by the light receiving element 64. A specific position of the window section 65 will be discussed later.

The light emitting element 62 is driven to be lit ON or OFF by a drive circuit (not shown) in accordance with a control signal output from the controller 100. The light receiving element 64 is connected to the controller 100 via an analog-to-digital (A/D) converter (not shown) and outputs a detection signal which is converted to a digital signal by the A/D converter to the controller 100. The light emitting element 62 and the light receiving element 64 are housed within the housing 61 such that they are formed on a substrate 67, together with the drive circuit which drives the light emitting element 62 and the light receiving element 64.

The housing 61 is formed in a rectangular prism, and includes an opposing surface 61A which opposes the intermediate transfer belt 36. In the first exemplary embodiment, the housing 61 includes a recessed portion 63. The recessed portion 63 includes a bottom surface positioned farther inward than the opposing surface 61A and wall surfaces raised from the bottom surface. The recessed portion 63 includes this pair of wall surfaces opposing each other and another pair of wall surfaces that connect the first pair of wall surfaces. The window section 65 is disposed on the bottom surface of the recessed portion 63 with the detection surface 69 facing outward. Detection light is emitted through the detection surface 69 and reflected light is received through the detection surface 69. That is, the window section 65 is surrounded by four wall surfaces. Although in this example the recessed portion 63 is formed such that it has a rectangular space, it is not restricted this shape. The length, the width, and the depth of the recessed portion 63 are indicated by “L”, “W”, and “D”, respectively.

Within the image forming apparatus, due to the movement of the intermediate transfer belt 36, airflow is generated. Toner scattering from the density detection image group G floats around the light amount detector 60 due to the presence of airflow. As stated above, the window section 65 is disposed on the bottom surface of the recessed portion 63, which makes the distance from the density detection image group G to the detection surface 69 longer, thereby suppressing adhesion of toner floating around the light amount detector 60 to the detection surface 69. Additionally, the window section 65 is surrounded by the four wall surfaces, which blocks the entry of airflow to the window section 65, thereby further reducing adhesion of toner to the detection surface 69.

The housing 61 also includes an optical waveguide 66 through which detection light is guided from the light emitting element 62 to the window section 65 and an optical waveguide 68 through which reflected light is guided from the window section 65 to the light receiving element 64. The recessed portion 63 is formed for both the light emitting element 62 and the light receiving element 64. Thus, the area of the detection surface 69 of the window section 65 which is exposed to the outside is increased, thereby making it easy to clean the detection surface 69.

Detection light emitted from the light emitting element 62 propagates within the optical waveguide 66, passes through the window section 65, and is applied to the density detection image group G formed on the intermediate transfer belt 36. Light reflected by the density detection image group G passes through the window section 65, propagates within the optical waveguide 68, and is received by the light receiving element 64. As viewed from the intermediate transfer belt 36 to the window section 65, detection light is emitted from a region of the detection surface 69 corresponding to the optical waveguide 66, and is incident on a region of the detection surface 69 corresponding to the optical waveguide 68.

As the light emitting element 62, a light emitting element that emits light in a visible region or in an infrared region, such as a light emitting diode (LED), is used. As the light receiving element 64, a light receiving element having sensitivity to detection light, such as a photodiode (PD), is used. As the window section 65, a transparent member that transmits detection light and reflected light, such as a glass sheet or a resin sheet, is used. As the housing 61, a light shielding member that blocks detection light and reflected light is used.

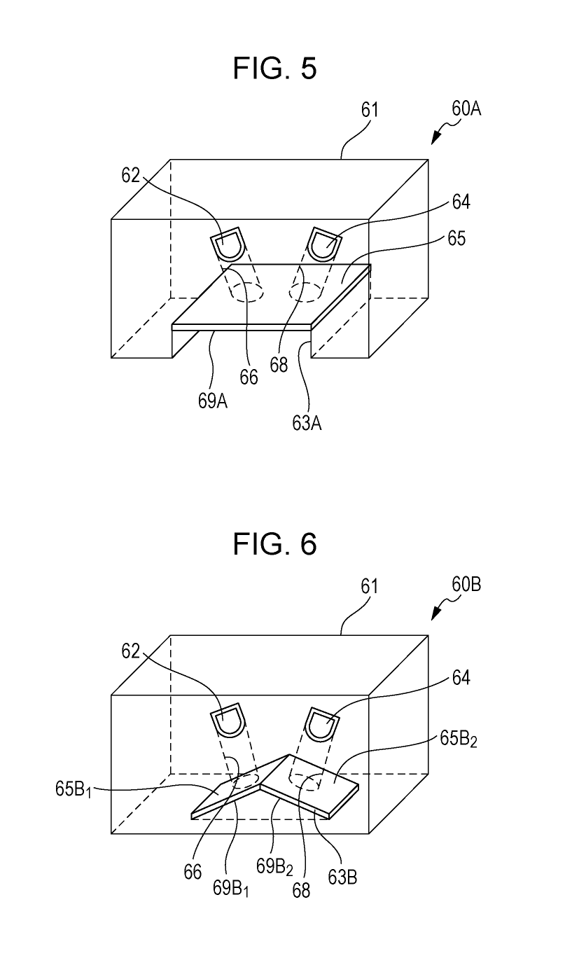

In the above-described example, the recessed portion 63 is formed such that the window section 65 is surrounded by four wall surfaces. However, the recessed portion 63 is not restricted to this structure. FIG. 5 is a perspective view illustrating a light amount detector 60A of a modified example of the first exemplary embodiment shown in FIGS. 4A through 4C. In this modified example, the configuration of the light amount detector 60A is the same as that of the light amount detector 60 of the first exemplary embodiment, except that a recessed portion 63A includes only one pair of wall surfaces. Thus, in FIG. 5, the same elements as those shown in FIGS. 4A through 4C are designated by like reference numerals, and an explanation thereof will thus be omitted.

As shown in FIG. 5, in the light amount detector 60A, the recessed portion 63A of the housing 61 includes a bottom surface positioned farther inward than the opposing surface 61A and a pair of wall surfaces raised from the bottom surface. The recessed portion 63A includes only one pair of wall surfaces opposing each other with respect to the bottom surface. That is, the recessed portion 63A is formed as a groove having a bottom surface and a pair of wall surfaces. However, the recessed portion 63A does not have any wall surface in the direction in which the groove extends. The window section 65 is disposed on the bottom surface of the recessed portion 63A with the detection surface 69A facing outward. Detection light is emitted through the detection surface 69A and reflected light is received through the detection surface 69A.

In the case of the structure shown in FIG. 5, the light amount detector 60A is arranged such that a pair of wall surfaces of the recessed portion 63A serve as walls that protect the detection surface 69A from airflow, that is, the extending direction of the groove and the flowing direction of the airflow intersect with each other. For example, if the airflow is generated in the direction in which the intermediate transfer belt 36 moves, the light amount detector 60A is disposed such that the arrangement direction of a pair of wall surfaces intersects with the moving direction of the intermediate transfer belt 36. With this arrangement, although the window section 65 is not surrounded by four wall surfaces, the pair of wall surfaces blocks the entry of airflow to the window section 65, thereby suppressing adhesion of toner floating around the light amount detector 60A to the detection surface 69A.

### Second Exemplary Embodiment

The configuration of a light amount detector 60B according to a second exemplary embodiment will be described below with reference to a perspective view of FIG. 6.

The configuration of the light amount detector 60B is the same as that of the light amount detector 60 of the first exemplary embodiment shown in FIGS. 4A through 4C, except for the configuration of a recessed portion and the arrangement of a window section. Thus, in FIG. 6, the same elements as those shown in FIGS. 4A through 4C are designated by like reference numerals, and an explanation thereof will thus be omitted.

In the light amount detector 60B shown in FIG. 6, a recessed portion 63B of the housing 61 includes a linear bottom segment positioned farther inward than the opposing surface 61A and oblique surfaces obliquely extending from linear the bottom segment. The recessed portion 63B includes this linear bottom segment, this pair of oblique surfaces, and a pair of wall surfaces which are interconnected to the pair of oblique surfaces. A window section 65B₁ is disposed on one oblique surface of the recessed portion 63B, while a window section 65B₂ is disposed on the other oblique surface of the recessed portion 63B. The window section 65B₁ is disposed such that a detection surface 69B₁ faces outward, and the window section 65B₂ is disposed such that a detection surface 69B₂ faces outward.

Detection light emitted from the light emitting element 62 propagates within the optical waveguide 66, passes through the window section 65B₁, and is applied to the density detection image group G formed on the intermediate transfer belt 36. Light reflected by the density detection image group G passes through the window section 65B₂, propagates within the optical waveguide 68, and is received by the light receiving element 64.

The window sections 65B₁ and 65B₂ are disposed on the oblique surfaces of the recessed portion 63B, which makes the distance from the density detection image group G to the detection surfaces 69B₁ and 69B₂ longer, thereby suppressing adhesion of toner floating around the light amount detector 60B to the detection surfaces 69B₁ and 69B₂. Additionally, the recessed portion 63B includes, not only a pair of oblique surfaces, but also a pair of wall surfaces, which block the entry of airflow to the window sections 65B₁ and 65B₂, thereby further suppressing adhesion of toner to the detection surfaces 69B₁ and 69B₂. The recessed portion 63B is formed for both the light emitting element 62 and the light receiving element 64. Thus, the areas of the detection surfaces 69B₁ and 69B₂ which are exposed to the outside are increased, thereby making it easy to clean the detection surfaces 69B₁ and 69B₂.

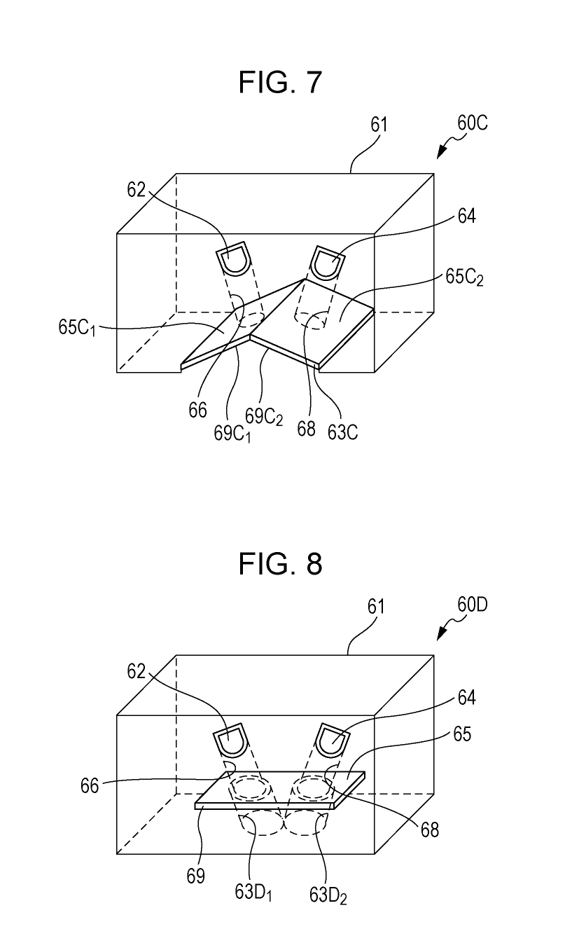

In the second exemplary embodiment, a recessed portion having a pair of wall surfaces in addition to a pair of oblique surfaces is formed. However, the recessed portion is not restricted to this structure. FIG. 7 is a perspective view illustrating a light amount detector 60C of a modified example of the second exemplary embodiment. In this modified example, the configuration of the light amount detector 60C is the same as that of the light amount detector 60B of the second exemplary embodiment, except that a recessed portion 63C incudes only a pair of oblique surfaces. Thus, in FIG. 7, the same elements as those of the light amount detector 60B are designated by like reference numerals, and an explanation thereof will thus be omitted.

In the light amount detector 60C of this modified example, the recessed portion 63C of the housing 61 includes a linear bottom segment positioned farther inward than the opposing surface 61A and oblique surfaces obliquely extending from the bottom segment. The recessed portion 63C includes only this linear bottom segment and this pair of oblique surfaces. That is, the recessed portion 63C is formed in a V-shaped groove which includes a linear bottom segment and a pair of oblique surfaces. However, the recessed portion 63C does not include any wall surface in the direction in which the groove extends. A window section 65C₁ is disposed on one oblique surface of the recessed portion 63C, while a window section 65C₂ is disposed on the other oblique surface of the recessed portion 63C.

In the case of the structure shown in FIG. 7, the light amount detector 60C is arranged such that a pair of oblique surfaces serve as walls that protect detection surfaces 69C₁ and 69C₂ from airflow, that is, the extending direction of the groove and the flowing direction of airflow intersect with each other. With this arrangement, although the recessed portion 63C does not include a pair of wall surfaces, the entry of airflow to the window sections 65C₁ and 65C₂ is reduced by the presence of the pair of oblique surfaces, thereby suppressing adhesion of toner floating around the light amount detector 60C to the detection surfaces 69C₁ and 69C₂.

### Third Exemplary Embodiment

The configuration of a light amount detector 60D according to a third exemplary embodiment will be described below with reference to a perspective view of FIG. 8.

The configuration of the light amount detector 60D is the same as that of the light amount detector 60 of the first exemplary embodiment shown in FIGS. 4A through 4C, except for the configuration of a recessed portion. Thus, in FIG. 8, the same elements as those shown in FIGS. 4A through 4C are designated by like reference numerals, and an explanation thereof will thus be omitted.

As shown in FIG. 8, a window section 65 is disposed within a housing 61 such that a detection surface 69 faces outward. The housing 61 includes a first recessed portion 63D₁ and a second recessed portion 63D₂, which are formed in the shape of a hole. The first recessed portion 63D₁ guides detection light emitted through the detection surface 69 of the window section 65 to the opposing surface 61A. The second recessed portion 63D₂ guides reflected light incident on the opposing surface 61A to the detection surface 69 of the window section 65. The diameter of the first recessed portion 63D₁ is greater than the diameter of the optical path of the optical waveguide 66 which is coaxial with the first recessed portion 63D₁. The diameter of the second recessed portion 63D₂ is greater than the diameter of the optical path of the optical waveguide 68 which is coaxial with the second recessed portion 63D₂.

Detection light emitted from the light emitting element 62 propagates within the optical waveguide 66 and passes through the window section 65. The detection light further propagates within the first recessed portion 63D₁ and is then applied to the density detection image group G formed on the intermediate transfer belt 36. Light reflected by the density detection image group G propagates within the second recessed portion 63D₂ and passes through the window section 65. The reflected light further propagates within the optical waveguide 68 and is then received by the light receiving element 64.

The window section 65 is disposed within the housing 61, which makes the distance from the density detection image group G to the detection surface 69 longer, thereby suppressing adhesion of toner floating around the light amount detector 60D to the detection surface 69. Additionally, the first and second recessed portions 63D₁ and 63D₂ are formed in a shape of a hole, which blocks the entry of airflow to the window section 65, thereby further suppressing adhesion of toner to the detection surface 69. Since the diameters of the first and second recessed portions 63D₁ and 63D₂ are formed greater than the diameters of the optical paths of the optical waveguides 66 and 68, respectively, the detection surface 69 can be cleaned properly without leaving a light transmission region unclean.

### Fourth Exemplary Embodiment

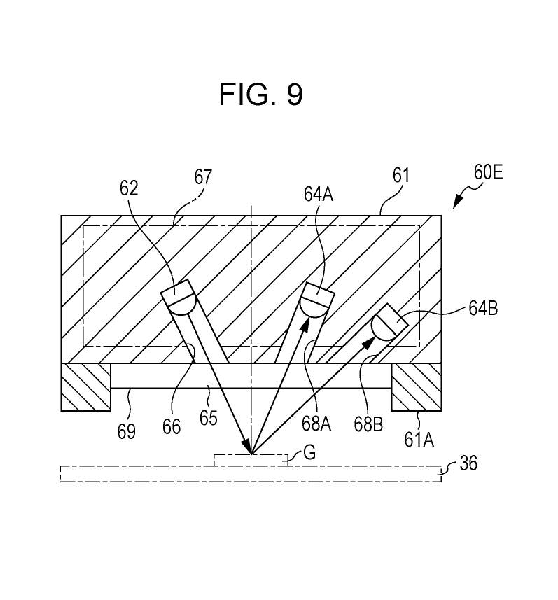

The configuration of a light amount detector according to a fourth exemplary embodiment will be described below with reference to FIG. 9.

FIG. 9 is a sectional view along the optical axis illustrating the configuration of a light amount detector 60E according to the fourth exemplary embodiment. The configuration of the light amount detector 60E is the same as that of the light amount detector 60 of the first exemplary embodiment shown in FIGS. 4A through 4C, except that another light receiving element is provided so as to receive diffused light reflected by a subject irradiated with detection light. Thus, in FIG. 9, the same elements as those shown in FIGS. 4A through 4C are designated by like reference numerals, and an explanation thereof will thus be omitted.

The light amount detector 60E includes, as shown in FIG. 9, a light emitting element 62 that emits detection light to be applied to a subject, a light receiving element 64A that receives regular reflection light obtained as a result of being reflected by a subject, a light receiving element 64B that receives diffused reflection light generated as a result of being reflected by a subject, and a window section 65 that transmits detection light and reflected light. The light emitting element 62, the light receiving elements 64A and 64B, and the window section 65 are supported by a support member (not shown) and are housed in a housing 61.

The light receiving element 64A is disposed at a position at which it receives regular reflection light obtained as a result of being reflected by a subject irradiated with detection light. The light receiving element 64B is disposed at a position at which it receives diffused reflection light generated as a result of being reflected by the subject irradiated with detection light. Accordingly, the light receiving element 64A is disposed between the light emitting element 62 and the light receiving element 64B. The housing 61 includes an optical waveguide 66 that guides detection light from the light emitting element 62 to the window section 65, an optical waveguide 68A that guides reflected light from the window section 65 to the light receiving element 64A, and an optical waveguide 68B that guides reflected light from the window section 65 to the light receiving element 64B.

Detection light emitted from the light emitting element 62 propagates within the optical waveguide 66, passes through the window section 65, and is then applied to the density detection image group G formed on the intermediate transfer belt 36. Regular reflection light obtained as a result of being reflected by the density detection image group G passes through the window section 65, propagates within the optical waveguide 68A, and is then received by the light receiving element 64A. Part of diffused reflection light generated as a result of being reflected by the density detection image group G passes through the window section 65, propagates within the optical waveguide 68B, and is then received by the light receiving element 64B.

As in the first exemplary embodiment, it is possible to suppress the adhesion of toner floating around the light amount detector 60E to the detection surface 69, and also, the area of the detection surface 69 exposed to the outside is increased, thereby making it easy to clean the detection surface 69. The light receiving element 64B that receives diffused reflection light is susceptible to the influence of an unclean area of the detection surface 69. However, since the adhesion of toner floating around the light amount detector 60E to the detection surface 69 is suppressed, the amount of diffused reflection light received by the light receiving element 64B is detected with high precision, and also, the amount of regular reflection light received by the light receiving element 64A is detected with high precision.

### Modified Examples

In order to further suppress the adhesion of floating toner to a detection surface, a light amount detector may include the following element. For example, a voltage applying function that applies a voltage having the same polarity as toner may be disposed on the opposing surface of a housing which opposes an image carrier. Moreover, a coating which attracts toner thereto, such as a metallic coating, may be applied to part of the opposing surface. Alternatively, a resin-made projection, such as a urethane projection, may be provided on the opposing surface so as to surround a region corresponding to a window section.

In the above-described exemplary embodiments, a light amount detector is disposed such that it performs downward detection. However, a light amount detector may perform detection in a different direction as long as it is disposed at a position at which the detection surface of a window section does not get dirty by toner dropped from an image carrier. Additionally, in the above-described exemplary embodiments, the amount of light reflected by density detection images is detected. Alternatively, the amount of light reflected by misregistration detection images may be detected.

The configurations of the light amount detector and the image forming apparatus discussed in the above-described exemplary embodiments and modified examples are only examples, and may be changed without departing from the spirit of the invention. For example, the image carrier may be replaced by a drum.

The foregoing description of the exemplary embodiment and the modified examples of the present invention has been provided for the purposes of illustration and description. It is not intended to be exhaustive or to limit the invention to the precise forms disclosed. Obviously, many modifications and variations will be apparent to practitioners skilled in the art. The embodiment and the modified examples chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A light amount detector comprising:
an irradiation unit that irradiates an image carrier with detection light;
a light receiver that receives reflected light obtained as a result of being reflected by the image carrier;
a housing that stores therein the irradiation unit and the light receiver and that includes an opposing surface which opposes the image carrier; and
a window section that includes a detection surface through which the detection light is emitted and the reflected light is received, that is supported by the housing, that is disposed such that the detection surface is positioned farther inward than the opposing surface of the housing, and that transmits the detection light and the reflected light.

2. The light amount detector according to claim 1, wherein:
the housing includes a recessed portion, the recessed portion including a bottom surface disposed farther inward than the opposing surface and wall surfaces raised from the bottom surface; and
the window section is disposed on the bottom surface of the recessed portion such that the detection surface faces outward.

3. The light amount detector according to claim 2, wherein the wall surfaces are disposed so as to surround the recessed portion.

4. The light amount detector according to claim 1, wherein:
the housing includes a recessed portion, the recessed portion including a linear bottom segment and a pair of oblique surfaces obliquely extending from the linear bottom segment, the linear bottom segment being disposed between the irradiation unit and the light receiver and being disposed farther inward than the opposing surface; and
the window section is disposed on the pair of oblique surfaces of the recessed portion such that the detection surface faces outward.

5. The light amount detector according to claim 4, wherein the recessed portion includes a pair of wall surfaces which are interconnected to the pair of oblique surfaces and which are disposed within the housing.

6. The light amount detector according to claim 1, wherein:
the window section is disposed within the housing such that the detection surface faces outward; and
the housing includes a first recessed portion and a second recessed portion, which are formed in a shape of a hole, the first recessed portion guiding the detection light emitted through the detection surface to the opposing surface, the second recessed portion guiding the reflected light received through the opposing surface to the detection surface.

7. The light amount detector according to claim 6, wherein a diameter of the first recessed portion is greater than a diameter of an optical path of the detection light, and a diameter of the second recessed portion is greater than a diameter of an optical path of the reflected light.

8. The light amount detector according to claim 1, wherein the detection surface intersects with an optical path of the detection light in a first region and intersects with an optical path of the reflected light in a second region, an area of the detection surface being greater than a total area of the first region and the second region.

9. The light amount detector according to claim 1, wherein the light receiver includes a first light receiving element that receives regular reflection light obtained as a result of being reflected by the image carrier and a second light receiving element that receives diffused reflection light generated as a result of being reflected by the image carrier.

10. An image forming apparatus comprising:
an image forming unit that forms an image on an image carrier;
a measuring unit that includes a light amount detector disposed above the image carrier and that measures an amount of light reflected by the image carrier or a density detection image formed on the image carrier;
a storage unit that stores an amount of at least part of light reflected by the image carrier as a reference value;
a density obtaining unit that obtains a density level of the density detection image by using the reference value and the amount of light reflected by the density detection image; and
a correcting unit that corrects a density level of an output image on the basis of the density level of the density detection image obtained by the density obtaining unit,
the light amount detector including
an irradiation unit that irradiates the image carrier with detection light,
a light receiver that receives reflected light obtained as a result of being reflected by the image carrier,
a housing that stores therein the irradiation unit and the light receiver and that includes an opposing surface which opposes the image carrier, and
a window section that includes a detection surface through which the detection light is emitted and the reflected light is received, that is supported by the housing, that is disposed such that the detection surface is positioned farther inward than the opposing surface of the housing, and that transmits the detection light and the reflected light.
